(19) United States
(12) Patent Application Publication
(10) Pub. No.: US 2018/0054142 A1
(43) Pub. Date: Feb. 22, 2018

(54) Low Load Speed Control for Blender

(71) Applicant: Hamilton Beach Brands, Inc., Glen Allen, VA (US)

(72) Inventors: Brian P Williams, Midlothian, VA (US); Joseph Elliott, Henrico, VA (US)

(21) Appl. No.: 15/679,832

(22) Filed: Aug. 17, 2017

Related U.S. Application Data
(60) Provisional application No. 62/377,009, filed on Aug. 19, 2016.

(51) Int. Cl. H02P 3/02; A47J 43/046; A47J 43/07

(52) U.S. Cl. CPC H02P 3/02; A47J 43/07; A47J 43/046

(57) ABSTRACT

A blender appliances includes a control mechanism to stop the blade from spinning within two seconds without the difficulty and expense of adding a brake. The subject blender detects the load reported from a motor load sensor and compares it to a predetermined threshold load. The motor operates at any of the user selected speeds if the motor is operating above the threshold load and operates at or less than a predefined first speed limit if the motor load is less than the threshold load.

### BACKGROUND OF THE DISCLOSURE

The present disclosure relates generally to small appliances, and more particularly to blenders.

Blenders are a household appliance capable of mixing liquids and chopping dry foods. Blenders are also useful for liquefying fruits and vegetables and for blending solids with liquids. A typical blender includes a jar that sits on top of a base or housing that encloses and controls a motor. The jar includes a blending tool rotatably mounted thereto. The blending tool is rotatably engageable with a drive shaft of the motor in an operating configuration. Foodstuff is placed into the jar, and the jar is engaged with the base. The motor is engaged, the foodstuff is blended, and the jar is removed from the base to dispense or pour the blended foodstuff.

It is known that removing the lid can trigger an interlock that disengages the motor. However, due to inertia, it is possible for the blade to continue rotating for some time period. In some applications, a physical brake may be activated to stop the blade more quickly. However, brakes add complexity and expense.

It has heretofore not been discovered how to create a blender where the blade stops spinning within two seconds without the difficulty and expense of adding a brake. The blender of the following disclosure accomplishes the above and other objectives and overcomes at least the above-described disadvantages of conventional blenders.

### SUMMARY OF THE INVENTION

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a blender, according to one embodiment of the present disclosure.

FIG. 2 is a flowchart of the operation of a blender of one embodiment of the present disclosure.

FIG. 3 is a block diagram of a control system of a blender, according to one embodiment of the present disclosure.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the present disclosure comprise a blender whose blade will stop within a desired amount of time (e.g., two seconds) of removing the lid, without using a brake.

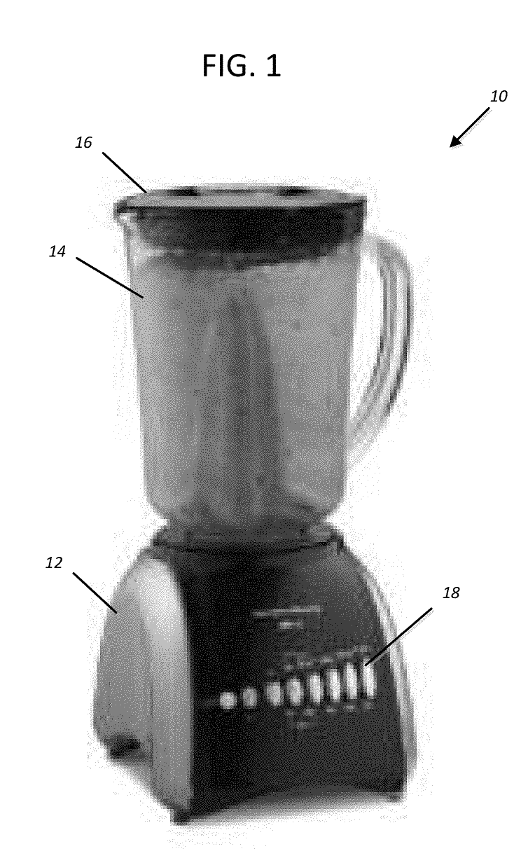

Referring to the drawings in detail, wherein like numerals indicate like elements throughout, FIG. 1 illustrates a blender 10 in which an embodiment of the present disclosure might be used. Blender 10 comprises a blender jar 14 selectively mountable onto a blender base or motor housing 12. The blender base 12 comprises a user interface 18, which may comprise a variety of user inputs and outputs. For example, the user interface 18 may comprise a plurality of selector buttons and/or switches and one or more indicator lights. The blender jar 14 has a removable lid 16. A motor and controller are housed within the blender base 12. When the blender is activated by a user, the motor causes a blade (not illustrated) within the blender jar 14 to rotate. The rotating blade mixes and/or chops the contents of the blender jar 14. The blender 10 has a Hall effect sensor (not illustrated) or the like to determine when the lid 16 has been removed from the blender jar 14 during operation of the blender.

The load on the motor will vary depending on the amount and type of contents in the blender jar. The fuller the blender jar is, the higher the load on the motor will be. Similarly, the denser the contents of the blender jar are, the higher the load on the motor will be. Conversely, the emptier the blender jar is, the lower the load on the motor will be. An empty blender jar will produce the lowest load on the motor.

If there is a sufficiently high load on the motor, then there is sufficient food or fluid (and/or sufficiently dense food or fluid) in the blender jar such that the blade will stop within two seconds (even without a brake) due to the friction on the blade from the blender jar contents. However, if the blender is being operated under a low load or no load condition (empty, small volume of fluid, etc.), then, depending on the speed (measured in revolutions per minute) at which the blender is being operated, the blade may not stop within two seconds due to the low amount of friction on the blade.

In embodiments of the present disclosure, the motor input is monitored at the start of a cycle by measuring input current, input wattage, or any similar measurable characteristic to determine the load on the motor. In one embodiment of the present disclosure, the trigger angle of a triac is used to determine the load. If there is sufficient load, the blender can be operated at whatever speed the user selects (up to the maximum speed). However, if the load is insufficient, a controller in the blender limits the blade speed to a speed that is predetermined to enable the blade to stop rotating within the required time limit, regardless of what speed the user selects. The load threshold (below which the controller limits the speed) and the speed limit may vary depending on, for example, the structure of the blender and the specific components used to construct the blender. The load threshold and speed limit may be determined empirically for each specific blender model, blade type, and the like.

In alternative embodiments of the disclosure, there may be multiple load thresholds and multiple corresponding speed limits. In one example of such an alternative embodiment, there may be two load thresholds. If the motor load is above the upper threshold, then the blender can be operated at whatever speed the user selects (up to the maximum speed). If the motor load is between the upper threshold and the lower threshold, then the speed is limited to a predefined first speed limit. If the motor load is below the lower threshold, then the speed is limited to a predefined second speed limit that is lower than the first speed limit. Any desired number of load thresholds and corresponding speed limits may be used.

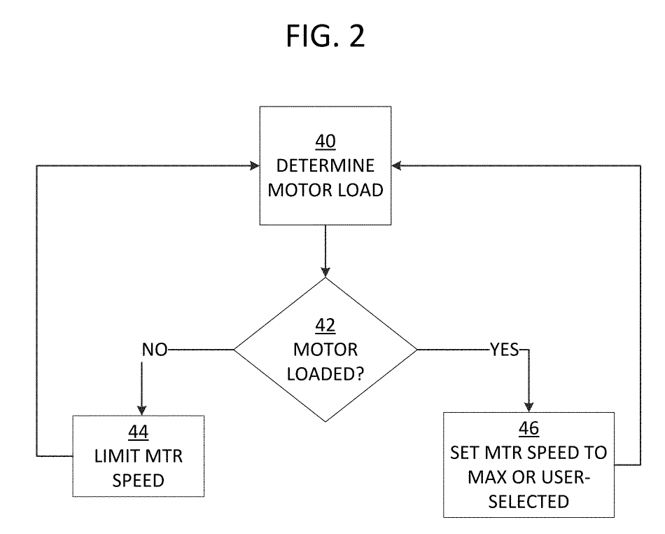

Referring now to FIG. 2, a flowchart of the operation of one embodiment of the present disclosure is illustrated. The motor load is determined, typically at the start of a cycle and on an on-going basis during the cycle. Block 40. The controller determines if the motor load is above or below the predetermined load threshold, which determines if the motor is sufficiently loaded to stop from any speed within the required time limit when the lid is removed. Block 42. If the motor is not sufficiently loaded, then the controller limits the blade speed to a speed that is predetermined to enable the blade to stop rotating within the required time limit when the lid is removed, regardless of what speed the user selects. Block 44. If the motor is sufficiently loaded, then the controller will run the blender at the user-selected speed or the maximum speed of the blender. Block 46. As indicated, the motor load will be determined on an on-going basis during the cycle.

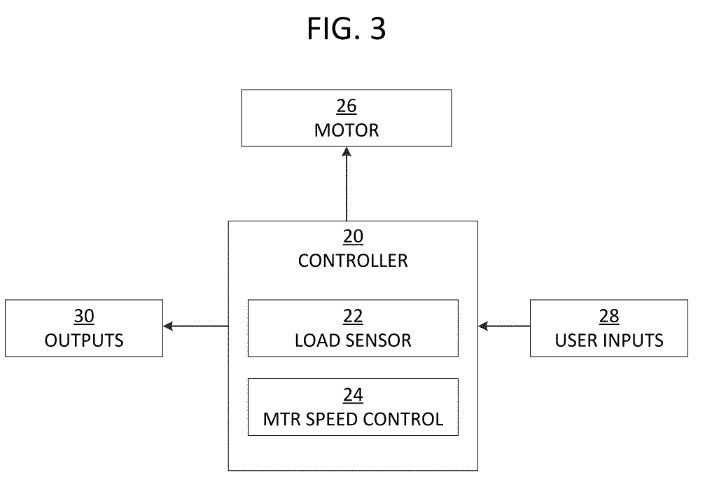

Referring now to FIG. 3, a block diagram of a control system of a blender is illustrated, according to one embodiment of the present disclosure. The blender control system may comprise a controller 20 that receives signals from one or more user inputs 28 (such as speed and/or cycle selection pushbuttons) and activates the motor 26 accordingly, such as via motor speed control module 24. The controller may also activate one or more outputs 30, such as indicator lights. The controller 20 may determine the motor load, such as via load sensing module 22 and limit or not limit the motor speed accordingly, as described above, via motor speed control module 24. The controller 20 may comprise a microprocessor, dedicated or general purpose circuitry (such as an application-specific integrated circuit or a field-programmable gate array), a suitably programmed computing device, or any other suitable means for controlling the operation of the blender.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A blender comprising:
a motor in a motor housing;
a blender jar with a removable lid;
a blade within the blender jar;
a controller;
a user interface providing a speed selection interface, the speed selection interface connected to the controller and the controller actuating the blade at the selected speed via the actuation of the motor;
a load sensor monitoring the load on the motor;
the controller comparing the load reported by the load sensor to at least a predetermined threshold load; and
wherein the motor operates at any of the user selected speeds if the motor is operating above the threshold load and operates at or less than a predefined first speed limit if the motor load is less than the threshold load.
